(19) United States
(12) Patent Application Publication
(10) Pub. No.: US 2004/0065706 A1
(43) Pub. Date: Apr. 8, 2004

(54) Bicycle accessory device

(76) Inventor: Neal A. Starks, Huntington Woods, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/676,774

(22) Filed: Oct. 1, 2003

Related U.S. Application Data
(60) Provisional application No. 60/415,638, filed on Oct. 2, 2002.

(51) Int. Cl. B62J 7/00; B62J 9/00; B62J 11/00

(52) U.S. Cl. 224/425

(57) ABSTRACT

A bicycle accessory device includes a bracket mounted on a bicycle frame. The bracket includes a tubular mount having two opposing holes. A support is removably received in the mount of the bracket. When the support is attached to the bracket, the lower end of the support includes two opposing spring biased pins which are received in the opposing holes. The upper end of the support also includes two opposing spring biased pins. A bicycle accessory includes opposing holes is removably attached to the support. When attached, the pins of the supports are received in the holes of the accessory. The accessory can be a storage rack, a flag, a gripping handle, a basket, or a kickstand.

### REFERENCE TO RELATED APPLICATIONS

This application claims priority to U.S. Provisional Patent Application No. 60/415,638 filed on Oct. 2, 2002.

### BACKGROUND OF THE INVENTION

The present invention relates generally to a bicycle accessory device including an accessory that is removably attached to a bicycle by a quick release attachment.

Baskets and racks are commonly attached to bicycles to hold objects that are to be transported during use of the bicycle. The baskets or racks are usually secured to either the front or the rear of the bicycle. At times, if no objects are being transported, it may be desirous to remove the basket or rack from the bicycle. A drawback to the prior art baskets and racks is that they are often bolted to or attached to the bicycle and not easily removable.

Flags, windcatchers, or other visual aids are also often attached to a bicycle. A flag can be used for decorative reasons or as a visual aid that provides notification to motorists and pedestrians. Flags are also often used for identification reasons, such as when bicyclists are part of a group or in a race. The flag or visual aid usually has to be permanently attached to the bicycle to securely fasten the flag or the visual aid to the bicycle. As with the baskets and racks described above, this creates a problem when the flag needs to be removed.

### SUMMARY OF THE INVENTION

A bicycle accessory device includes a bracket secured to a bicycle frame. The bracket includes a tubular mount having opposing holes, a first portion on one side of the mount, and a second portion on the opposing side of the mount. The first portion includes a pair of fingers that receive the bicycle frame, and the second portion includes a bolt hole that receives a bolt that secures the bracket to the bicycle.

A support is removably received in the mount by a quick release attachment. The lower end of the support includes two opposing spring biased pins that are received in the opposing holes of the mount. The upper end of the support also includes two opposing spring biased pins for the attachment of an accessory in a quick release attachment to the support.

In one example, the accessory is a storage rack including a plurality of bars. One of the bars is pivotally received in a T-shaped attachment mount including a pair of opposing holes. When the upper end of the support is received in the attachment mount, the spring biased pins in the upper end of the support are received in the holes in the attachment mount, securing the attachment mount and the storage rack to the bicycle.

Alternately, the accessory is a flag or windcatcher. The flag is attached to an adapter received in the upper end of the support with an interference fit.

The accessory can also be a gripping handle including two opposing holes. When the upper end of the support is inserted into an opening in the gripping handle, the spring biased pins of the support are received in the opposing holes of the gripping handle, securing the gripping handle to the support.

The accessory can also be a basket attached to the support by a connector. The connector includes two holes that receive the two spring biased pins of the upper end of the support. The connector is connected to the basket by a joint that allows for movement of the basket.

Finally, the accessory can be a kickstand. The kickstand includes a body portion having a pair of opposing spring biased pins that are received in the holes of the bracket. The body portion is pivotal about a pivot point so that the body portion can extend downwardly when the kickstand is in use and can pivot upwardly towards the rear of the bicycle when the bicycle is in use.

Other features and advantages of the invention will become apparent on reading the detailed description which follows of some embodiments of the invention, given by way of example only and with reference to the single figure.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a side view of a bicycle incorporating the bicycle accessory device of the present invention;

FIG. 2 illustrates the fingers of the bracket;

FIG. 3 illustrates a top view of the bracket;

FIG. 4 illustrates the attachment of the support to the bracket;

FIG. 5 illustrates a side view of a rack attached to the support;

FIG. 6 illustrates a top view of the rack;

FIG. 7 illustrates the pivoting of the rack from a left mount to a right mount;

FIG. 8 illustrates a perspective view of a rack mounted on two supports;

FIG. 9 illustrates a side view of a flag attached to the support;

FIG. 10 illustrates a side view of a grip handle mounted to the handle;

FIG. 11 illustrates a perspective view of a grip handle mounted on two supports;

FIG. 12 illustrates a perspective view of a cargo trailer mounted to one support;

FIG. 13 illustrates a schematic view of a first example joint;

FIG. 14 illustrates a schematic view of a second example joint; and

FIG. 15 illustrates a side view of a kickstand mounted to the bracket.

### DETAILED DESCRIPTION OF THE PREFERRED EMBODIMENT

FIG. 1 illustrates a bicycle accessory device 20 mounted on a bicycle 22. A mount bolt 28 secures a rear wheel 30 to a bicycle frame 24 and 26. A bracket 32 including a tubular mount 34 is fixed to the bicycle frame 24. Preferably, the mount 34 is perpendicular to the central axis of the bracket 32. The mount 34 includes two opposing holes 40. As shown in FIGS. 2 and 3, a first portion 42 of the bracket 32 includes a pair of fingers 35 having a C-shaped structure and an opening 36 defined between the fingers 35. The bracket 32 is mounted to the frame 24 such that the frame 24 is received in the opening 36 of the bracket 32. The fingers 35 are bent inwardly at an angle between 60° and 90° from the bracket 32 to facilitate mounting of the bracket 32 to the frame 24. Preferably, the fingers 35 are bent inwardly approximately 75°. The bracket 32 further includes a second portion 44 having an inwardly bent portion 46 that includes a bolt hole 38 (shown in FIG. 3) which receives the bolt 28. The bracket 32 is secured to the frame 24 by passing the bolt 28 through the bolt hole 38.

When attaching the bracket 32 to the bicycle 22, the bolt 28 is first removed from the bicycle 22. The bracket 32 is then attached to the bicycle 22 such that the frame 24 is received in the opening 36 between the fingers. The bolt 28 is then inserted into the bolt hole 38 and reattached to the bicycle 22, securing the bracket 32 to the bicycle 22. Although a bolt 28 has been described, it is to be understood that any type of attachment mechanism can be utilized.

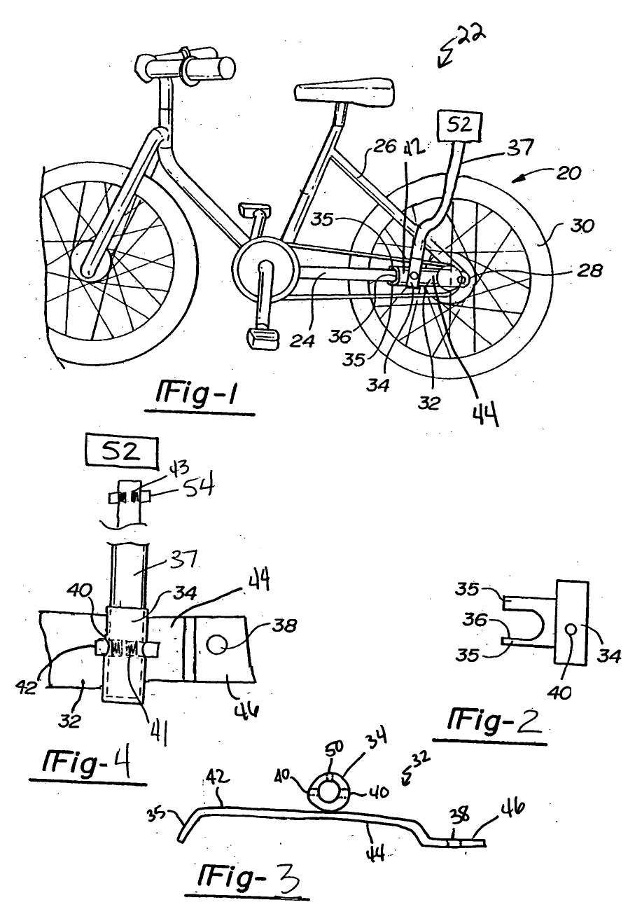

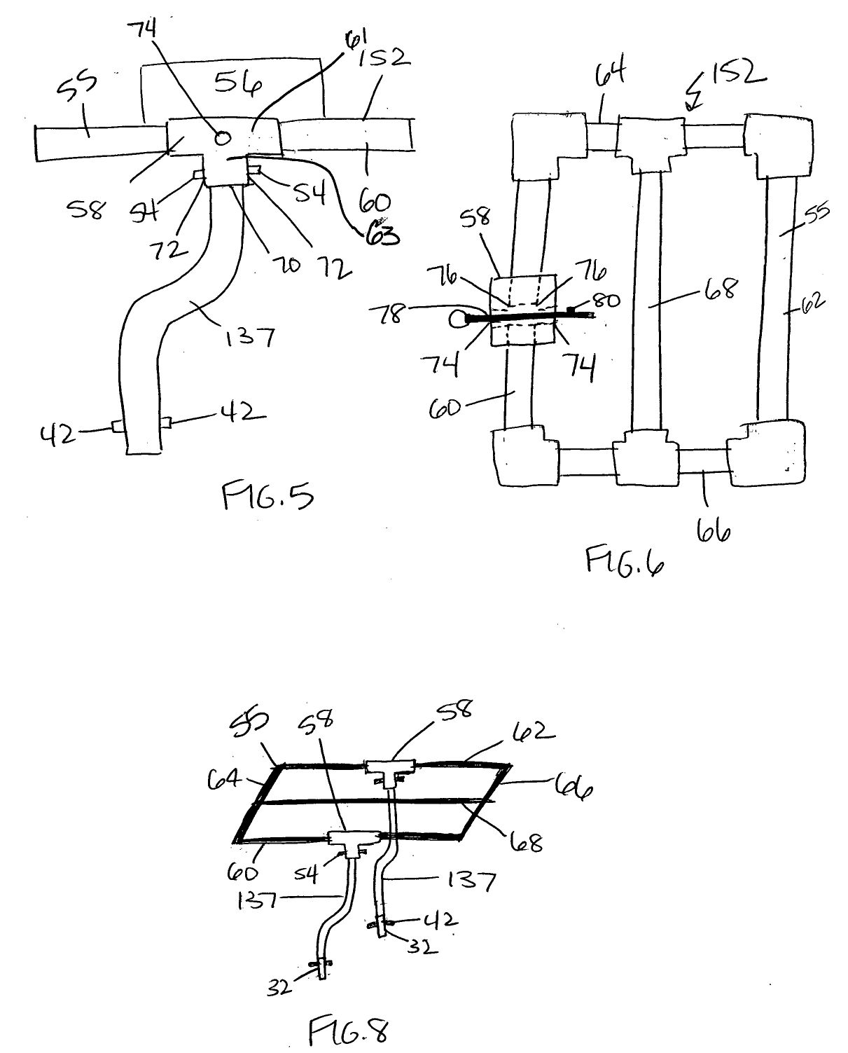

As illustrated in FIG. 4, a support 37 is removably received in the mount 34 and attached to the mount 34 by a quick release attachment. The lower end of the support 37 includes two opposing spring 41 biased pins or buttons 42 that are received in the opposing holes 40 of the mount 34. When the support 37 is attached to the mount 32, the spring 41 biased pins 42 are pressed inwardly, allowing the support 37 to be inserted into the mount 34. Once the pins 42 are aligned with the holes 40, the springs 41 bias the pins 42 outwardly, securing the support 37 to the mount 34. When the support 37 is to be removed from the mount 34, the pins 42 are pressed inwardly to compress the springs 41, removing the pins 42 from the holes 40. The support 37 can then be easily removed from the mount 34. The upper end of the support 37 also includes two spring 43 biased pins 54 for the attachment of an accessory 52 with a quick release connection.

Preferably, the pins 42 and 54 are on the same side of the support 37. However, it is to be understood that the pins 42 and 54 can be located in other positions. For example, the pins 54 can be located 90° from the pins 42. Additionally, although spring biased pins 42 and 54 are illustrated and described, it is to be understood that other types of attachment mechanisms are possible. For example, an elongated pin can be inserted into aligned holes to removably attach the components.

Returning to FIG. 3, the mount 34 can also include two opposing second holes 50. When the support 37 is attached to the mount 34, the pins 42 are received in the second holes 50, allowing the support 37 to be mounted 90° from the position illustrated in FIG. 1.

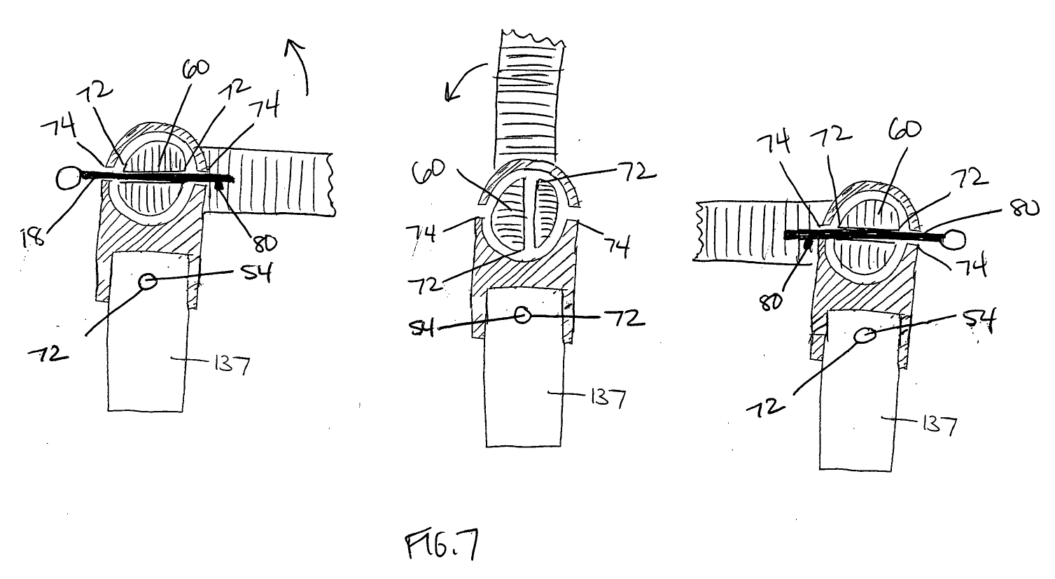

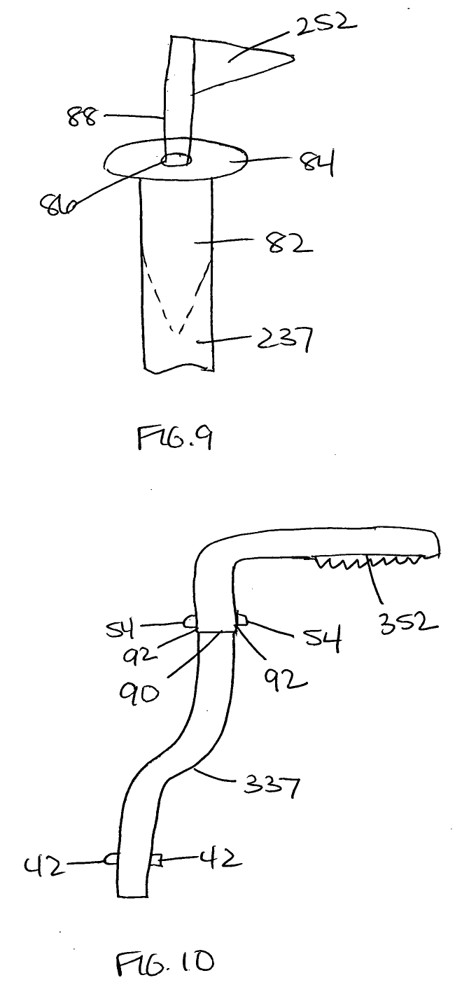

In one example, as shown in FIGS. 5 and 6, the accessory is a storage rack 152 removably attached to a support 137. The storage rack 152 includes a rack portion 55 that holds an object 56. In one example, the storage rack 152 is rectangular and includes four bars 60, 62, 64 and 66 that form the rectangular outer shape of the rack portion 55 and a center tube 68 parallel to and between the tubes 60 and 62. The support 137 has a length sufficient to clear the top of the rear wheel 30. Although a rectangular storage rack 152 has been illustrated and described, it is to be understood that other shapes of the storage rack 152 are possible.

The bar 60 of the storage rack 152 is pivotally received in a T-shaped attachment mount 58 removably attached to the support 137. The attachment mount 58 includes a top portion 61 and a perpendicular bottom portion 63. The bottom portion 63 of the attachment mount 58 includes two opposing holes 72. When the attachment mount 58 is attached on the support 137, the spring biased pins 54 of the support 137 are received in the opposing holes 72 of the attachment mount 58. When the attachment mount 58 is attached to the support 137, an upper end of the support 137 is received in an opening 70 in the bottom portion 63 of the attachment mount 58.

The top portion 61 of the attachment mount 58 also includes two opposing holes 74, and the bar 60 includes two opposing holes 76. When the rack portion 55 is positioned such that is it substantially parallel with the ground, the holes 74 and 76 substantially align. A pin 78 is inserted into the aligned holes 74 and 76 to retain the rack portion 55 in this position and to prevent pivoting of the rack portion 55. The pin 78 includes a spring biased protrusion 80 at an end of the pin 78 that prevents removal from the aligned holes 74 and 76. When the pin 78 is to be removed from the holes 74 and 76, the protrusion 80 is pushed inwardly against the bias of the spring, allowing removal of the pin 78. The pin 78 can also be tethered to the bicycle 22 to prevent loss.

The bracket 32 can be mounted on either the right side or the left side of the bicycle 22. When the device 20 is mounted on the left side of the bicycle 22, the rack portion 55 extends towards the right hand side of the bicycle 22 and is positioned over the rear wheel 30. If the device 20 is mounted on a bracket 32 on the right side of the bicycle 22, the rack portion 55 must be pivoted 180° to extend towards the left hand side of the bicycle 22 and to be positioned over the rear wheel 30. The protrusion 80 is pushed inwardly, allowing the pin 80 to be removed. The rack portion 55 can then be pivoted 180° about the tube 60 such that the rack portion 55 is positioned over the rear wheel 30. The pin 78 is then inserted into the aligned holes 72 and 74 to secure the rack portion 55 in the desired position and to prevent pivoting of the rack portion 55. It is to be understood that an outwardly biased spring 54 can be positioned inside the tube 60 that extends outwardly from the holes 74 and 76.

As illustrated in FIG. 8, the rack portion 55 can also be supported on both sides of the bicycle 22 to support heavier items 56. In this example, a bracket 32 is attached to each side of the bicycle 22, and a support 137 is removably attached to each bracket 32. An attachment mount 58 is located on both the outer tubes 60 and 62 of the rack portion 55. Each attachment mount 58 is removably attached to the upper ends of one of the supports 137 in the manner described above.

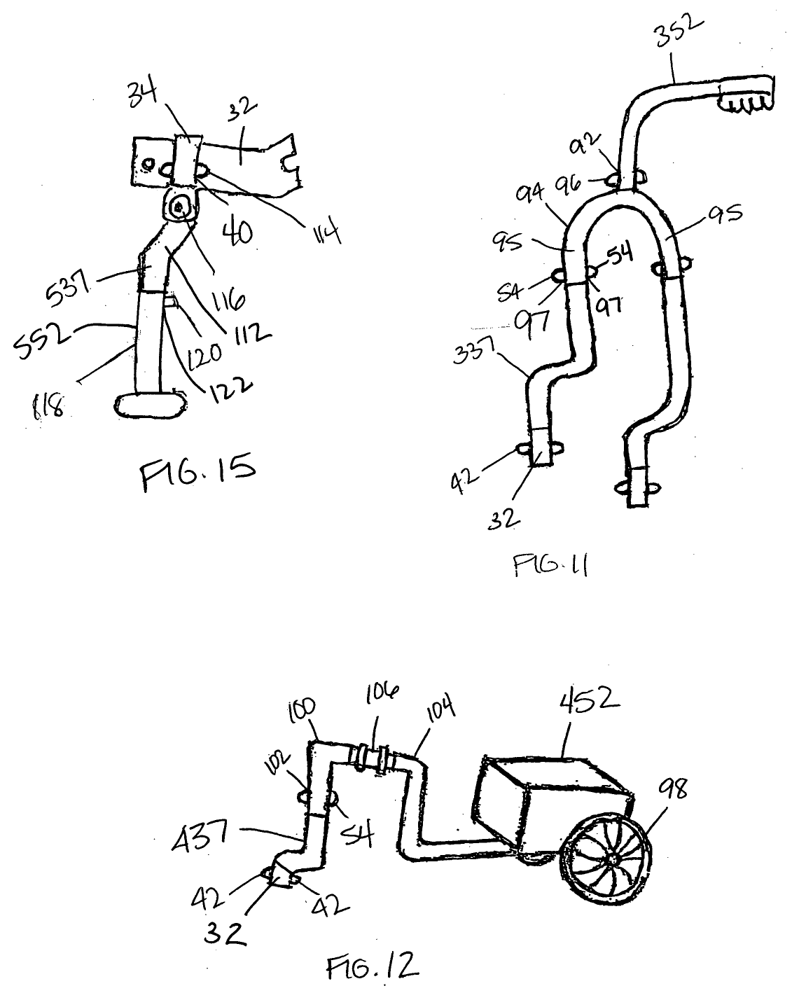

As shown in FIG. 9, the accessory can be a flag 252, wind catcher, or other visual signal. When employing a flag 252, it is preferable that the support 237 is longer than the support 137 employed with the storage rack 152 to raise the height of the flag 252 over the operator of the bicycle 22. An adapter 82 is inserted into the open upper end of the support 237, creating an interference fit between the adapter 82 and the support 237 to secure the adapter 82 to the support 237. The adapter 82 can also be attached to the support 237 by gluing, employing screws, or other suitable methods of attachment. Alternately, the adapter 82 is secured in the support 237 by spring biased pins. In this example, the adapter 82 includes holes that receive the spring biased pins located on the upper part of the support 237, removably securing the adapter 82 to the support 237.

The adapter 82 includes an enlarged top portion 84 having a hole 86. The enlarged top 84 has a diameter larger than the opening of the upper end of the support 237. The top 84 further includes a hole 86 that receives the post 88 of the flag 252. Preferably, the post 88 of the flag 252 is secured to the adapter 82 to prevent rotation of the post 88 during use of the bicycle 22. The post 88 can be secured to the adapter 82 by gluing, by employing a screw that passes through the post 88, or by any other suitable attachment method.

Alternatively, as shown in FIG. 10, the accessory 52 is a gripping handle 352 removably attached to the support 337. In this example, the support 337 is preferably longer than the support 137 used with the storage rack 152, but shorter than the support 237 used with the flag 252. The gripping handle 352 includes an opening 90 that receives the upper end of the support 337. The gripping handle 352 also includes two opposing holes 92 that receive the spring biased pins 54 on the upper portion of the support 337.

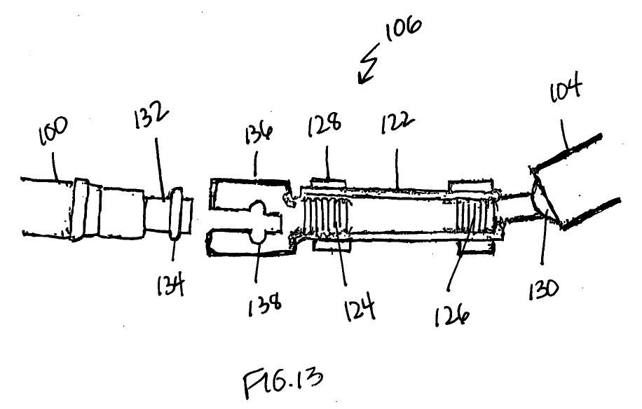

For additional support, as shown in FIG. 11, a bracket 32 can be attached to both sides of the bicycle 22. A bracket 32 is attached to each side of the bicycle 22, and a support 337 is removably attached to each bracket 32. A y-shaped connector 94 removably connects the handle 352 to the supports 337. Each support 337 includes a leg 95 that is removably attached to one of the two supports 337. Each leg 95 includes a pair of opposing holes 97 that receive the spring biased pins 54 in the upper portion of the supports 337. The connector 94 further includes an upper portion (not shown) having a pair of opposing spring biased pins 96. When the upper portion of the connector 94 is inserted into the gripping handle 352, the pins 96 of the connector 94 are received in the holes 92 of the gripping handle 352, removably attaching the gripping handle 352 to the bicycle 22. Alternately, a second connector 100 (shown in FIG. 12) is removably attached between the connector 94 and the handle 352.

As illustrated in FIG. 12, a basket 452 or other trailing device having wheels 98 can be attached to the support 437. A first connector 100 is removably attached to the support 437. The first connector 100 includes two opposing holes 102 that receive the pins 54 of the support 437 to removably attach the first connector 100 to the support 437. The basket 452 includes an arm 104 that extends from the basket 452. A joint 106, discussed below, joins the first connector 100 and the arm 104. For additional support, a bracket 32 can be attached to each side of the bicycle 22, and a support 437 is removably attached to each bracket 32 in as described above. In this example, the connector 100 includes two legs that each removably receive one of the supports 437.

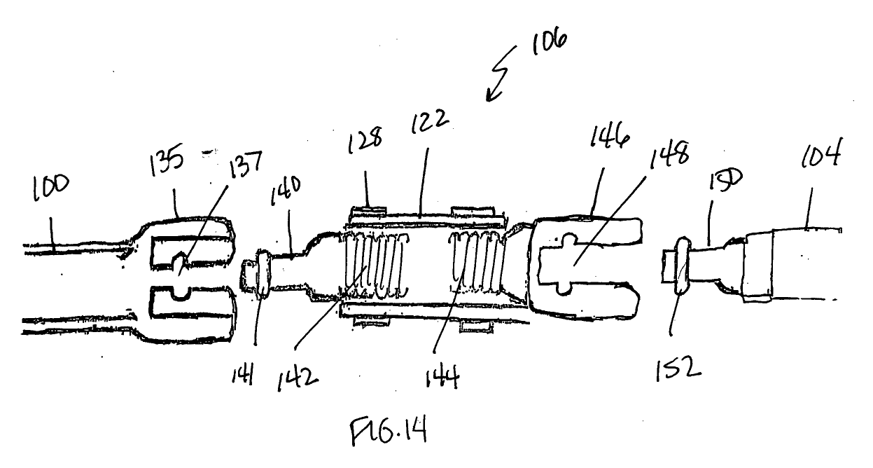

FIG. 13 illustrates a first embodiment of the joint 106 between the first connector 100 and the arm 104. In this embodiment, the first connector 100 includes a male part 132 having a locking lip 134 receivable an opening 132 of a female part 136 to receive the male part 132. The joint 106 allows for rotation between the male part 132 and the female part 136. The female part 136 further includes a metal ribbed connector 124 opposite to the opening 132. The ribbed connector 124 is inserted into an end of a rubber hose 122. The second connector 104 includes a swivel joint 130 and also has a metal ribbed connector 126 opposite to the swivel joint 130. The ribbed connectors 124 and 126 are each inserted into an end of a rubber hose 122. A band clamp 128 positioned over the outer surface of the hose 122 at the location of the inserted ribbed connectors 124 and 136 secures both the female part 136 and the second connector 114 to the hose 122. During operation of the bicycle 22, the swivel joint 130 and the rubber hose 122 increase the range of motion of the basket 425.

FIG. 14 illustrates an alternate joint 106 between the first connector 100 and the second connector 104. The first connector 100 includes a first female part 135 having an opening 137. A first male part 140 having a locking lip 141 is removably received in the opening 137 of the first female part 135. The joint 106 allows for rotation between the first female part 135 and the first male part 140. The first male part 140 further includes a metal ribbed connector 142. The second connector 104 attached to the basket 452 includes a second male part 150 having a locking lip 152. The second male part 150 is removably received in the opening 148 of a second female part 146. The joint 106 allows for rotation between the second male part 150 and the second female part 146. The second female part 150 further includes a metal ribbed connector 144. The metal ribbed connectors 142 and 144 are each inserted into an end of a rubber hose 122. A band clamp 128 positioned over the outer surface of the hose 122 at the location of the inserted ribbed connectors 142 and 144 secure the first male part 140 and the second female part 146 to the hose 122. During operation of the bicycle 22, the swivel joint 130 and the rubber hose 122 increase the range of motion of the basket 425. Although the joint 106 has been illustrated and described, it is to be understood that other suitable attachment methods could be used.

FIG. 15 illustrate a kickstand 552 removably attached to the bracket 32. The kickstand 552 includes a support 537 having a pair of opposing spring biased pins 114. When the support 537 is attached to the bracket 32, the pins 114 are received in the holes 40 of the bracket 32, removably connecting the support 537 to the bracket 32. The support 537 includes a body portion 112 is pivotal about a pivot point 116. The body portion 112 can pivot between an a first position in which the body portion 112 extends downwardly towards the ground to balance the bicycle 22 and a second position in which the body portion 112 is substantially parallel to the ground and the bicycle 22 can be used. A kickstand extension 118 is removably attached to the body portion 112 to allow for the height of the kickstand 552 to be adjusted. A spring biased pin 120 on one of the body portion 112 and the extension 118 is received in a hole 122 in the other of the body portion 112 and the extension 118 to removably attach the extension 118 to the body portion 112. The extension 118 can be external or internal of the body portion 112. The adjustment can also be made with a set screw to hold proper location.

Although the supports 37, 137, 237, 337 and 437 have been illustrated and described as being made of one part, it is to be understood that supports 37, 137, 237, 337 and 437 can include two removably attached part to reduce storage space. For example, the support 37, 137, 237, 337 and 437 can include a lower portion removably attached to an upper portion. Each portion includes one of either two spring biased pins or two opposing holes. The pins are received in the holes to secure the first portion to the second portion.

Although a storage rack 152, a flag mount 252, a gripping handle 352, a basket 452, and a kickstand 552 have been illustrated and described, it is to be understood that other accessories can be employed with the accessory device 20 of the present invention. Additionally, various types of supports, mounts and brackets can be incorporated into the present invention. Additionally, although it has been disclosed that the supports 37, 137, 237 and 337 include the spring biased pins 54 that are received in holes 72 and 92 of an accessory, it is to be understood that the supports 37, 137, 237 and 337 can include the holes and the accessory can include the spring biased pins.

Preferred embodiments of this invention have been disclosed, however, a worker of ordinary skill in the art would recognize that certain modifications would come within the scope of this invention. For that reason, the following claims should be studied to determine the true scope and content of this invention.

What is claimed is:

1. A bicycle accessory device comprising:
a bracket adapted to be mounted to a bicycle, said bracket including a mount;
a support removably connected to said mount;
a first quick release connection between said support and said mount;
a bicycle accessory removably connected to said support; and
a second quick release connection between said support and said bicycle accessory.

2. The device as recited in claim 1 wherein said bracket is secured to said bicycle by an attachment mechanism.

3. The device as recited in claim 1 wherein said mount is tubular.

4. The device as recited in claim 1 wherein said bracket includes a first portion having a pair of fingers that receive a frame of said bicycle and an opposing second portion having an aperture to receive an attachment mechanism that secured said bracket to said bicycle.

5. The device as recited in claim 1 wherein said support further includes a lower portion having one of two pins resiliently biased outwardly and two holes and said bracket further includes the other of said two pins and said two holes, and said two pins are received in said two holes when said support is attached to said bracket.

6. The device as recited in claim 1 wherein said two pins are pressed inwardly to remove said support from said bracket.

7. The device as recited in claim 1 wherein said support further includes an upper portion having one of two pins resiliently biased outwardly and two holes and said accessory includes the other of said two pins and said two holes, and said two pins are received in said two holes when said accessory is attached to said support.

8. The device as recited in claim 7 wherein said two pins are pressed inwardly to remove said accessory from said support.

9. The device as recited in claim 1 wherein said first quick release connection is aligned with said second quick release connection.

10. The device as recited in claim 1 wherein said removable accessory is a storage rack including a mount, and said mount is removably attached to said support.

11. The device as recited in claim 10 wherein said storage rack is pivotally attached to said mount.

12. The device as recited in claim 10 further including a pin, wherein said storage rack includes a first hole and said mount includes a second hole, and said pin is inserted into said first hole when aligned with said second hole to prevent pivoting of said storage rack relative to said mount.

13. The device as recited in claim 1 wherein said removable accessory is a flag.

14. The device as recited in claim 1 wherein said removable accessory is a handle.

15. The device as recited in claim 1 wherein said removable accessory is a wheeled trailing device.

16. The device as recited in claim 15 further including a flexible tube between said support and said trailing device.

17. The device as recited in claim 1 wherein said removable accessory is a kickstand, and said support includes a pivot.

18. A method of removably attaching a bicycle accessory comprising the steps of:
removably attaching a support to the bicycle with a first quick release connection; and
removably attaching a removable accessory to said support with a second quick release connection.
